(19) United States
(12) Patent Application Publication
(10) Pub. No.: US 2009/0272243 A1
(43) Pub. Date: Nov. 5, 2009

(54) AUTOMATED DOUBLE SAW

(76) Inventor: JEAN-FRANCOIS DESROSIERS, St-Louis-de-Blandford (CA)

Correspondence Address: GOUDREAU GAGE DUBUC, 2000 MCGILL COLLEGE, SUITE 2200, MONTREAL, QC, H3A 3H3, CA

(21) Appl. No.: 12/114,181

(22) Filed: May 2, 2008

(51) Int. Cl. B27B 5/20

(52) U.S. Cl. 83/471.2; 83/507

(57) ABSTRACT

A saw assembly, comprising a first top bench and a second top bench, a first cutting head mounted on the first top bench and a second cutting head mounted on the second top bench, each cutting head comprising a wall having a first side and a second side; a plate rotatable around a pivot mount mounted on the first side of the wall; a unit indexing a movement of the plate from the second side; and a blade, mounted on the first side of the wall by an arm rotataly connected to the wall by the plate.

### FIELD OF THE INVENTION

The present invention relates to saws. More specifically, the present invention is concerned with an automated double saw.

### BACKGROUND OF THE INVENTION

In the industry of door and window manufacturing for instance, machining equipment is needed for installation, modification and repair, and efforts are being made to automate available equipment.

It appears that conventional sawing tools fail to meet particular needs in industry manufacturing, especially considering an ongoing rapid evolution in the conception and fabrication processes. For example, vinyl extrusions now appearing on the market have dimensions outgrowing the cutting capacity of current saws and are available with a variety of shapes that challenges the limit of versatility of the conventional tools. In particular, the wide range of thickness now available for vinyl extrusions results in repeated and time-consuming tool adjustments, thereby jeopardizing productivity.

Therefore, there is a need for tools allowing enhanced performances in terms of speed and dimensionality control for example, as well as allowing a wider range of operating conditions in order to adapt to a varied geometry of work pieces, while remaining cost effective.

### SUMMARY OF THE INVENTION

More specifically, there is provided a saw assembly, comprising a first top bench and a second top bench, a first cutting head mounted on the first top bench and a second cutting head mounted on the second top bench, each cutting head comprising a wall having a first side and a second side; a plate rotatable around a pivot mount mounted on the first side of the wall; a unit indexing a movement of the plate from the second side; and a blade, mounted on the first side of the wall by an arm rotataly connected to the wall by the plate.

Other objects, advantages and features of the present invention will become more apparent upon reading of the following non-restrictive description of embodiments thereof, given by way of example only with reference to the accompanying drawings.

### BRIEF DESCRIPTION OF THE DRAWINGS

In the appended drawings:

FIG. 1 is a general perspective view of a tool according to an embodiment of the present invention;

FIG. 2 are close up perspective views of a saw head of the tool of FIG. 1 with a saw at an angle of 90°;

FIG. 3 are close up perspective views of a saw head of the tool of FIG. 1 with a saw at an angle of 45°;

FIG. 4 illustrate a structural support for the saw of the tool of FIG. 1;

FIG. 5 is a detail of an indexation system and structural support of the saw according to an embodiment of the present invention;

FIG. 6 is a close up view of a pivot mount of the structural support for the saw of the tool of FIG. 1;

FIG. 7 is an exploded perspective view of a bearing surface for the saw blade rotation; and

FIG. 8 illustrates the bearing surface of FIG. 7.

### DESCRIPTION OF EMBODIMENTS OF THE INVENTION

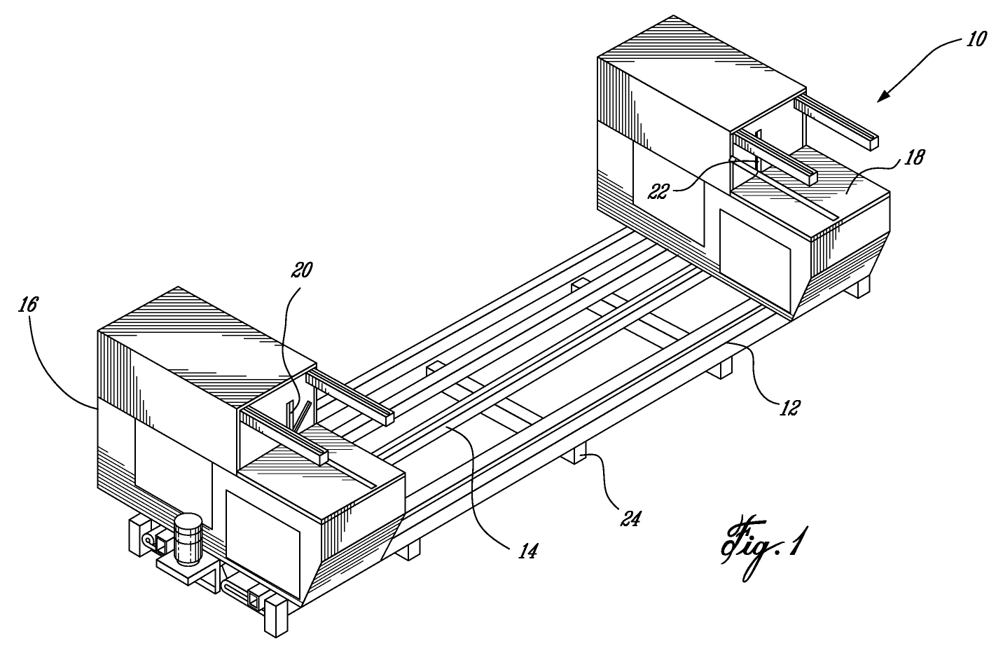

As illustrated in FIG. 1 of the appended drawings, the saw 10 comprises a structural stand 12, a positioning belt 14 extending between a first top bench 16 and a second top bench 18 defining a cutting bench, a first saw head 20 mounted on the first top bench 16 and a second saw head 22 mounted on the second top bench 18.The structural stand 12, which may optionally be provided with adjustable structural support arms 24, is strong and distortion-free.

A workpiece to be processed is fed between the first top bench 16 and the second top bench 18 from the side. The workpiece is then supported by the first top bench 16 and the second top bench 18, the reference being the outside perimeter of the workpiece, i.e an extrusion comprising a frame and mouldings and trimming extruded directly on the frame for example, which results in an increased precision of cut since the measured surface is used as a reference surface, in contrast with equipment where the workpiece is measured from an inner perimeter thereof, i.e an extrusion measured by its frame not including the mouldings and trimmings, which are assembled in a second step.

Obviously the provision of two cutting heads 20, 22 allows an increased cutting rate. One of the two top benches (top bench 18 for example in FIG. 1) is mobile, driven by the positioning belt 14, while the other one is fixed (top bench 16, blocked by pin 17 for example in FIG. 1). Therefore, the overall length between the first top bench 16 and the second top bench 18, i.e. the length of the cutting bench, may be adjusted, from a minimum separation of the two blades when the top benches 16 and 18 are side to side (in case of small workpieces obviously) to up to 3.5 meters (in case of larger workpieces), by sliding the top bench 16, towards or away from, the top bench 18, on the positioning belt 14.

The present invention comprises optimizing the structure of the cutting head by reducing a number of components thereof and by reducing the dimensions of the remaining components thereof, thereby allowing to strike an optimized balance between the cutting path, the cutting height (as measured by the rake angle) and the dimensions of the cutting bench of the saw.

The two saw heads 20 and 22 are essentially identical. Either one may be a mobile head.

Each cutting head comprises a saw housing 30 receiving a saw blade 32.

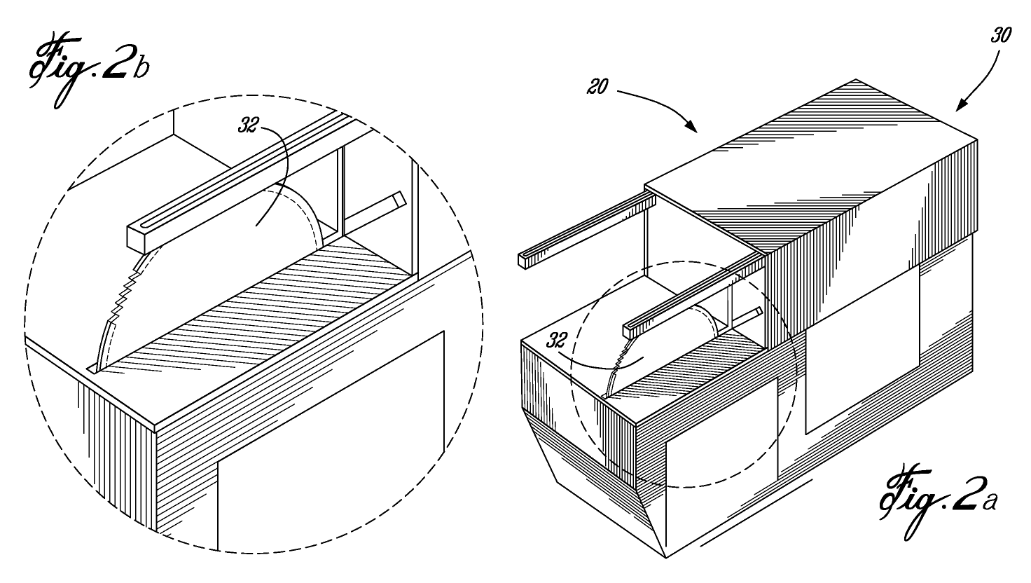

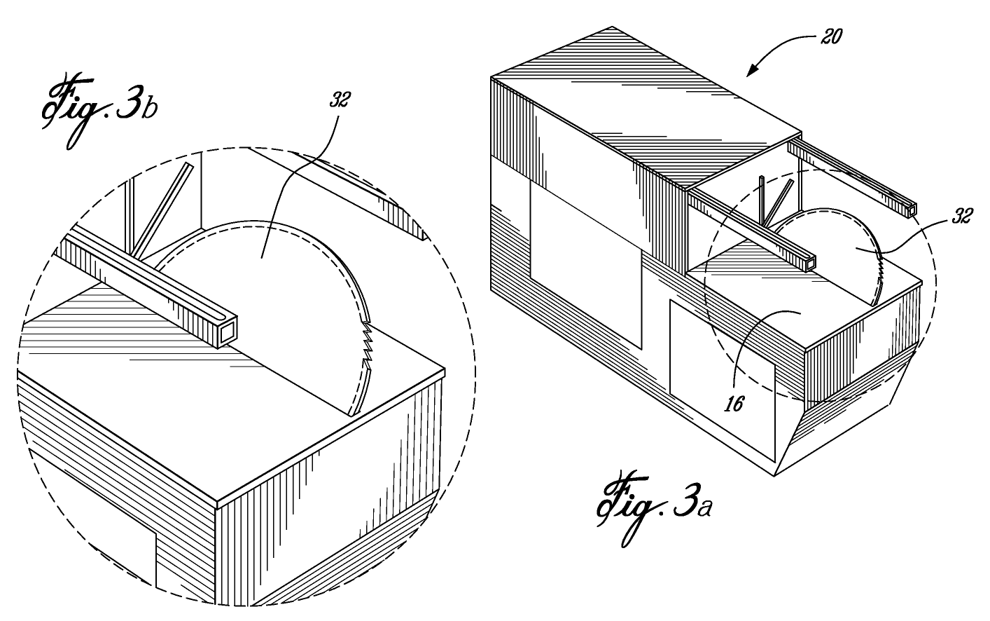

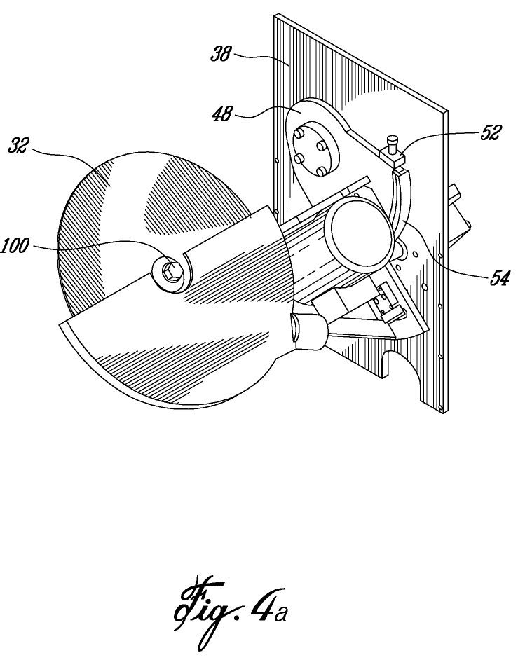

An increased cutting path, up to 15″ (381 mm) by 25″ (635 mm) is obtained by using 24 inches diameter sawblades 32 of 24 for example. The center of the saw blades 32 are positioned lower than the benches 16, 18, which allows a longer travel of the saw blades 32, referred to as the cutting length (see FIGS. 2 and 3).

The mobile saw blade has a linear movement actuated by hydropneumatic cylinder adjustable by a flow-regulating valve to provide an increased cutting rate and cutting precision by operating simultaneously on both cutting heads.

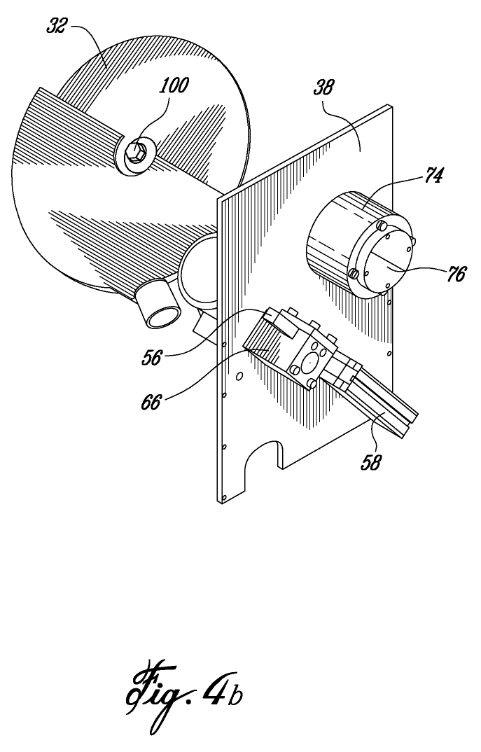

As shown in FIG. 4b, a rear movement mechanism allows a movement of the blade 32 from the rear end of the saw 10, radially under the top bench 16, which permits to accommodate a blade of an increased diameter in comparison to a diameter of 18″ for the diameter of the blades that can currently be mounted on the available tools, without requiring a larger width of the saw housing 30, which therefore maintains the possibility of a reduced minimum separation between the two saw blades in the case of small workpieces. Moreover, the lowered position center of the blades permits a higher blade diameter and an increased cutting length. Also, the larger diameter allows a larger cutting height.

Thus, it makes possible to determine dimensions of the workpiece to be cut on the basis of the dimensions of the window frame instead of on the basis of the dimensions of the windowpane, in the case of a window application for example. Such a feature results in the elimination of lengthy and fastidious iterative adjustments and corrections that are usually necessary when cutting different workpieces.

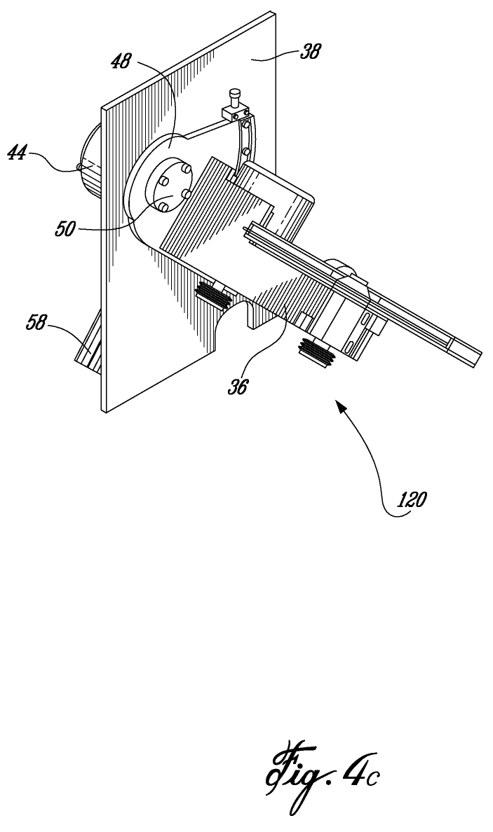

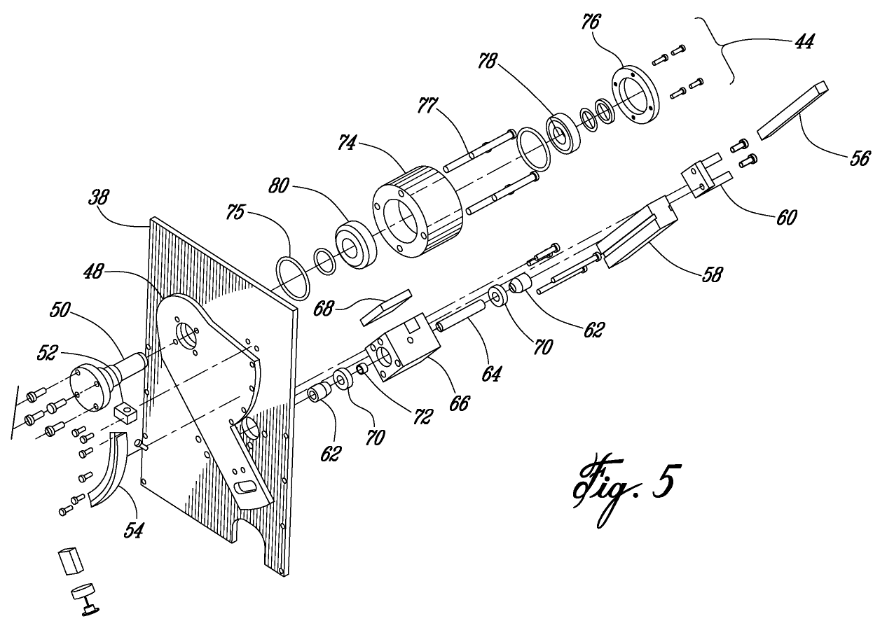

A cross-cut indexation mechanism is provided as will be discussed herein below in FIG. 5.

The saw blade 32 may be accommodated for angle cuts between 45° and 90° to either side (see FIGS. 2, 3), by an indexation mechanism of the blade, as will be described hereinbelow.

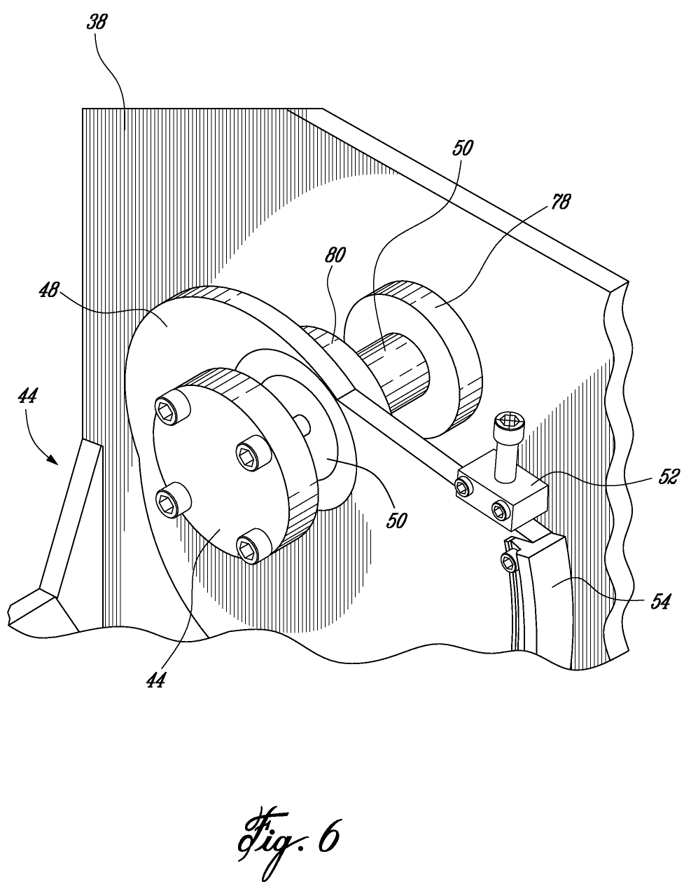

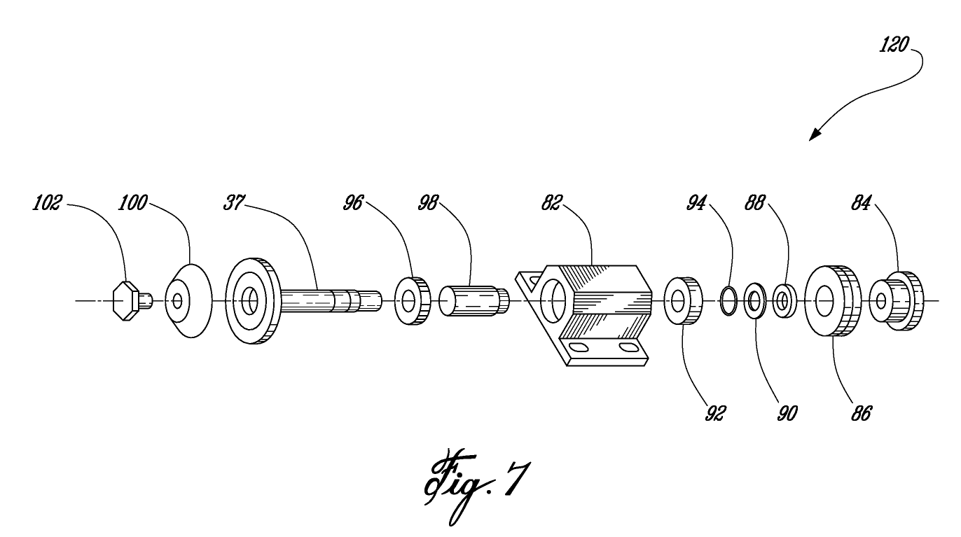

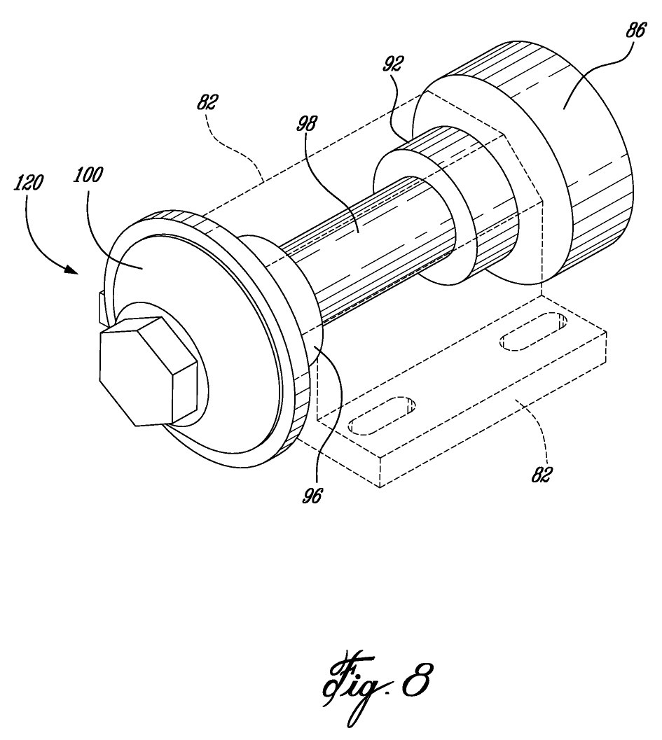

As shown in FIGS. 4, the blade 32 is mounted about a blade shaft 100 mounted to an arm 36 rotataly connected to the rear wall 38 by the back plate 48, the plate 48 being rotatable around a pivot mount 44 detailed in FIGS. 5 and 6, an arrangement detailed in FIG. 5 transferring an indexation movement from the rear side (see FIG. 4b) of the rear wall 38.

As best seen in FIG. 5, the movement of the back plate 48 shown in FIG. 4(a) is indexed, on the opposite side of the back plate 48 best seen in FIG. 4(b), by a pit wheel 54 and limited by a stopper 52, through a gearing mechanism comprising a curved rack 56 and its shaft 64, its block 66 and its back 68, an indexation cylinder 58 and its support 60. The rack shaft 64 is maintained relative to the rack block 66 by gears 62 and bearings 70 separated by a spacer 72 (see FIGS. 5 and 4b).

The back plate 48 drives the main pivot shaft 50 of the pivot mount 44, supporting a counterbalancing bushing 74 provided with its cap 76 and conical bearings 78 and 80, and sealed on each sides by O-rings 75 and 77 as shown in FIGS. 5 and 6, which keep contaminants out of the bushing 74 housing the bearings 78 and 80.

On the side of the blade 32, as best seen in FIG. 4(c), the blade 32 is mounted in rotation around rod 37 using a bearing surface 120.

As detailed in FIGS. 7 and 8, the bearing surface 120 comprises a bearing support 82 maintained by a taper ring 84 engaging a double pulley 86, a clamp holder 88 and its washer 90, a double row bearing 92 and a washer 94 separated from a simple bearing 96 by a bearing spacer 98. A blade spacer 100 and a blade bolt 110 complete the system.

Such a conical bearing arrangement maintains the blade from the center thereof with an improved load distribution, which allows maintaining the rigidity of the assembly including the motor and the blade, as the blade is indexed from 90 degrees to 45 degrees over time. Provision of O-rings on each side of the counterbalancing bushing 74 further allows preventing oscillations of the assembly.

People in the art will appreciate that the present invention allows a rake angle in the range comprised between 45° and 90°, while protecting the mechanism from contaminants, such as wood pieces, that would jeopardize the precise operation thereof, and therefore request adjustments.

From the foregoing, it should now be apparent that the saw of the present invention has an optimized cutting head structure, including a structural support for the rotation of the blade and a mechanism of indexation of the rake angle, which allows using blades of a large diameter, for example 20″, 22″ and 24″. Moreover, the structure is adaptable to any dimension of a workpiece and to variability in the thickness of the workpiece of 0.5 mm as compared to 0.15 mm in the current tools. A hydro pneumatic system drives the blades.

Prior art tools are limited to the use of blades of a diameter of 18″ (457.2 mm), and to machine extrusions of less than 4″ in thickness, while available extrusions may now have a thickness reaching 4½″ (114.3 mm) at an angle of 45 degrees, which requires, when considering the thickness of the template, a cutting height of up to 5″ (127 mm), i. e. blades of a diameter of 22″ (558.8 mm) or up to 24″ (609.6 mm). The cutting head optimizing of the present invention results in an increase of the cutting path and of the cutting height without modifying the dimensions of the cutting bench, and also in an increase of the cutting path without reducing the precision of the reference point of the saw.

The workpiece to be cut by the saw of the present invention may be a plastic profile for a door or a window for example. People in the art will appreciate that the present invention is suitable for cutting aluminum, wood and vinyl profiles and similar material.

Clearly, a multiple angle saw according to the present invention is capable of cutting round top windows, round top sills, octagon windows. Each saw blade may be stroke independently. Moreover, the angle of each saw blade can be adjusted to a range of angles.

The saw blade used herein may be for example carbide tipped circular saw blade.

Interestingly, the tool of the present invention may be fully automated and programmable, and remotely monitored from an operator control station. Automation may be achieved according to custom needs by using versatile electronic components.

People in the art will appreciate that the saw of the present invention benefits from an improved structural support of rotation, of a controlled indexation of the rake angle and of an advantageous mechanism of the blade movement, yielding an enhanced control of the speed and of the advance of the saw blades.

Therefore, the saw of the present invention meets a range of varied needs related to an increasing variety of shapes and dimensions of vinyl extrusions for doors and windows for example, including the range of thickness thereof, in terms of cutting capacity, cutting rate, and precision of cut.

Although the present invention has been described hereinabove by way of embodiments thereof, it may be modified, without departing from the nature and teachings of the subject invention as defined in the appended claims.

What is claimed is:

1. A saw assembly, comprising a first top bench and a second top bench, a first cutting head mounted on the first top bench and a second cutting head mounted on the second top bench, each cutting head comprising:
a wall having a first side and a second side;
a plate rotatable around a pivot mount mounted on the first side of said wall;
a unit indexing a movement of said plate from said second side; and
a blade, mounted on the first side of the wall by an arm rotataly connected to the wall by said plate.

2. A saw assembly according to claim 1, wherein said movement of the plate is limited by a pit wheel and a stopper positioned on said first side of the wall.

3. A saw assembly according to claim 1, wherein said unit indexing the movement of said plate movement comprises a gearing mechanism comprising:
a curved rack, a shaft of said rack being maintained relative to a block of said rack by gears and bearings separated by a spacer; and
an indexation cylinder.

4. A saw assembly according to claim 1, wherein said plate drives a main pivot shaft of said pivot mount on said second side of the wall, said main pivot shaft supporting a counterbalancing bushing provided with conical bearings and sealed on each sides thereof by O-rings.

5. A saw assembly according to claim 1, wherein said blade is rotataly mounted about a rod located at a center thereof using a bearing surface, said bearing surface comprising a bearing support maintained by a taper ring engaging a double pulley, a double row bearing and a washer separated from a simple bearing by a bearing spacer.

6. A saw assembly according to claim 5, said bearing surface further comprising a blade spacer and a blade bolt.

7. A saw assembly according to claim 1, wherein said blade is indexable from 90 degrees to 45 degrees.

8. A saw assembly according to claim 1, wherein a center of the blades is positioned lower that the benches.

9. A saw assembly according to claim 1, wherein said blades have a diameter of up to 24 inches, a cutting path between said first top bench and said second top bench being up to 15″ by 25″.

10. A saw assembly according to claim 1, further comprising a positioning belt extending between said first top bench and said second top bench, wherein at least one of the cutting head is mobile.

11. A saw assembly according to claim 10, wherein the at least one mobile cutting head has a linear movement actuated by hydropneumatic cylinder adjustable by a flow-regulating valve.
